(19) United States
(12) Patent Application Publication
(10) Pub. No.: US 2025/0303291 A1
(43) Pub. Date: Oct. 2, 2025

(54) ENABLING THE TRACKING OF A REMOTE-PLAY CLIENT IN VIRTUAL REALITY WITHOUT ADDITIONAL SENSORS

(71) Applicant: Sony Interactive Entertainment Inc., Tokyo (JP)

(72) Inventor: Rathish Krishnan, San Mateo, CA (US)

(21) Appl. No.: 18/623,749

(22) Filed: Apr. 1, 2024

(51) Int. Cl. A63F 13/537; A63F 13/26; A63F 13/355

(52) U.S. Cl. CPC A63F 13/537; A63F 13/26; A63F 13/355; A63F 2300/8082

(57) ABSTRACT

To provide tracking information for a device such as a remote portal for a video game that does not have LED tracking lights to enable a virtual representation of the device to be presented in a VR presentation on a head-mounted display (HMD), fiducial markers such as bar codes or QR codes are encoded into the game video sent to the device. A camera images the markers and the images are used to generate tracking data of the device for the VR system. The VR system can thus present a virtual image of the device including the gameplay video being shown on the real world device except that the fiducials are cropped out and the virtual video on the virtual device upscaled on the HMD. The markers also may trigger video enhancements to the game presented on the HMD as triggered by in-game events.

### FIELD

The present application relates generally to enabling the tracking of a remote-play client in virtual reality (VR) without additional sensors.

### BACKGROUND

As understood herein, computer simulations such as computer games may involve one or more players wearing headsets such as virtual reality (VR) or augmented reality (AR) head-mounted displays (HMDs). Some VR systems may use external sensors or cameras to detect infrared (IR) light emitted by LEDs on the controllers, allowing the controllers to be tracked. As a result, VR headsets can track only a few devices that include LEDs and are paired with the VR system. For instance, the PSVR2 can track the PSVR2 Sense controllers that include IR LEDs but not DualSense controllers or PlayStation Portal devices that do not have these IR LEDs.

### SUMMARY

VR tracking of devices without tracking LEDs is provided without adding additional components (such as LEDs) to the device by embedding fiducial markers, such as QR codes, in the video stream shown on the screen of the device, which consequently can be tracked by, e.g., a camera on the VR headset. When viewed through the VR headset, a virtual image of the device is seen that displays the video stream being shown on the real world device but without the fiducial markers.

Accordingly, an apparatus includes at least one virtual reality (VR) headset and at least one component such as a “remote portal” for a computer game that is separate from the VR headset and that has at least one display. The apparatus includes at least one source of at least one computer simulation presentable on the VR headset. At least one visible fiducial marker is presented on the component, while an image of the component as if playing the computer simulation is displayed on the VR headset without the visible fiducial marker.

The fiducial marker is useful for tracking the component. Moreover, presenting the fiducial marker may be in response to an in-game action and may be correlatable to a video enhancement on the VR headset. The enhancement is not sourced from the source of the computer simulation.

In some embodiments, the component can be configured to present the computer simulation with the visible fiducial marker superimposed on the computer simulation. The computer simulation presented on a display of the component can be identical to the computer simulation when presented on the VR headset except that the computer simulation when presented on the display of the component is shown with the at least one visible fiducial marker and the computer simulation when presented on the VR headset is shown with no visible fiducial markers.

In some examples, the computer simulation when presented on the VR headset is presented on a virtualization of the component.

In example embodiments, the fiducial marker in the computer simulation when presented on the VR headset is cropped out and the computer simulation up-scaled when presented on the VR headset. Plural fiducial markers may be presented in respective corners of the computer simulation. Without limitation, a fiducial marker can include a quick response (QR) code representing tracking information.

In another aspect, a device includes at least one computer storage that is not a transitory signal and that in turn includes instructions executable by at least one processor assembly to receive from at least one camera at least one image of at least one component of a computer simulation system. The instructions are executable to, based at least in part on at least one fiducial marker in the at least one image, generate a virtual representation of the component and also based at least in part on the fiducial marker, generate a video enhancement. The instructions are executable to present the virtual representation of the component and the video enhancement in at least one computer simulation on a virtual reality (VR) display without the fiducial marker.

In another aspect, a method includes presenting at least one computer simulation on at least one display of at least one component. The method also includes presenting, in the computer simulation on the display of the component, at least one fiducial marker, imaging the fiducial marker, and generating information using the imaging useful for generating an image of the component. The method includes presenting the image of the component on at least one display other than the component.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example specific system consistent with present principles;

FIG. 3 illustrates a controller or other device to be tracked using visible fiducial markers;

FIG. 4 illustrates example logic in example flow chart format for embedding fiducial markers into a game video;

FIG. 5 illustrates example logic in example flow chart format for tracking a device using the fiducials;

FIG. 6 illustrates example logic in example flow chart format for using the tracking information to present an image of the device on a display such as a head-mounted display (HMD);

FIG. 7 illustrates example logic in example flow chart format for modifying fiducials to account for game events;

FIG. 8 illustrates downscaling and inclusion of fiducial markers presented on a real world (RW) device to enable the device to be tracked by VR systems;

FIG. 9 illustrates a virtual image of the device as seen through a VR headset, which uses fiducial markers to track and position the virtual image in the game, with the video stream shown in the virtual image being cropped and upscaled to remove the fiducial markers;

FIG. 10 illustrates an example software architecture; and

FIG. 11 illustrates a data structure correlating fiducial codes to desired actions in VR.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

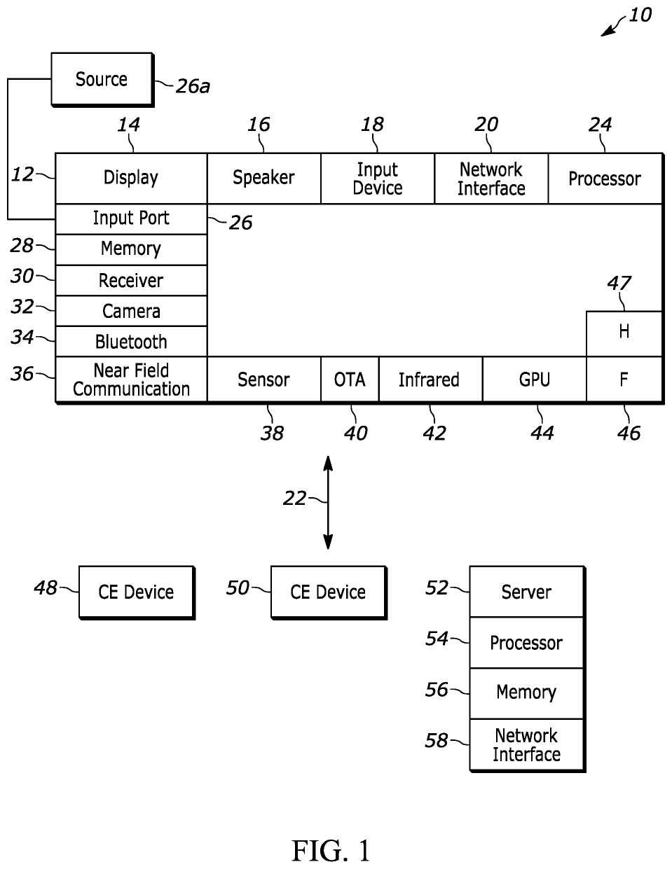

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the aforementioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Large language models (LLM) such as generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

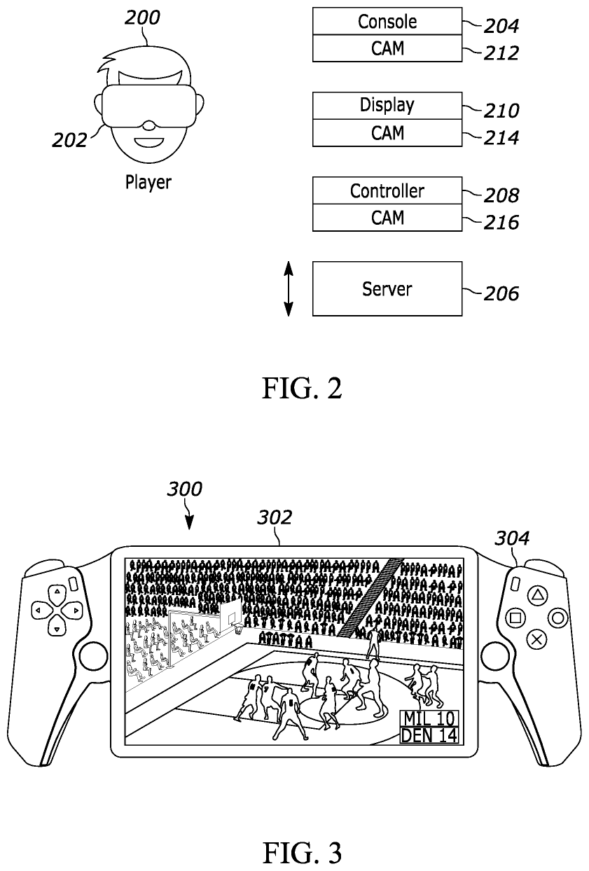

Refer now to FIG. 2. A player 200 of a computer simulation such as a computer game can wear a headset 202 such as a virtual reality (VR) or augmented reality (AR) head-mounted display (HMD) to play a computer simulation sourced from a computer game console 204 or streamed from a server 206. The player 200 may control the simulation using a computer simulation controller 208 such as a PlayStation controller. The controller 208 is a non-limiting example of a device to be tracked consistent with principles herein using a technique that allows gamers to stream gameplay from computer simulation (such as PlayStation) consoles to any compatible device.

An auxiliary display 210 such as a TV also is shown on which the simulation may be presented. Respective cameras 212, 214, 216 may be provided on the console 204, display 210, and controller 208 to image the player 200 and environs. Also, tracking cameras can be built into the outer surface of the headset in addition to the eye tracking camera.

FIG. 3 illustrates a component or device 300 that may be configured as a remote portal for a computer game, in the example shown, configured similar to a computer game controller with a display 302 for presenting game video and plural control handles 304 with buttons that can be manipulated to control the game presented on the display 302. The game may be streamed from a source such as a computer game console or game server system. As shown, the component or device 300 has no tracking features such as LEDs apart from the fiducial-based techniques described here. The component or device 300 also may lack any motion sensors and position sensors. A non-limiting example of the device 300 is a DualSense® controller. Other examples include PlayStation® Portal devices. Still other examples of the device 300 may include a game controller such as a DualSense controller that is attached to a mobile device which acts as a Remote Play client.

A fiducial marker is a visible pattern embedded in video having a known pattern and size to serve as a real world anchor of location, orientation and scale, as well as a code for certain computer action described herein. A fiducial marker can indicate scene or object identities as well as type of device 300 and location information of the marker, such as “top right corner of display”. In non-limiting examples, a fiducial marker may be established by one or more quick response (QR) codes and/or bar codes and a processor receiving an image of such a marker may estimate the translation, orientation, and vertical depth of a known-size marker relative to the camera to ascertain the location/position/orientation (collectively, “pose”) of the device 300. Thus, a fiducial marker may be configured to allow rapid, low-latency detection of 6D position estimation (3D location and 3D orientation) and identity of many other unique fiducial information.

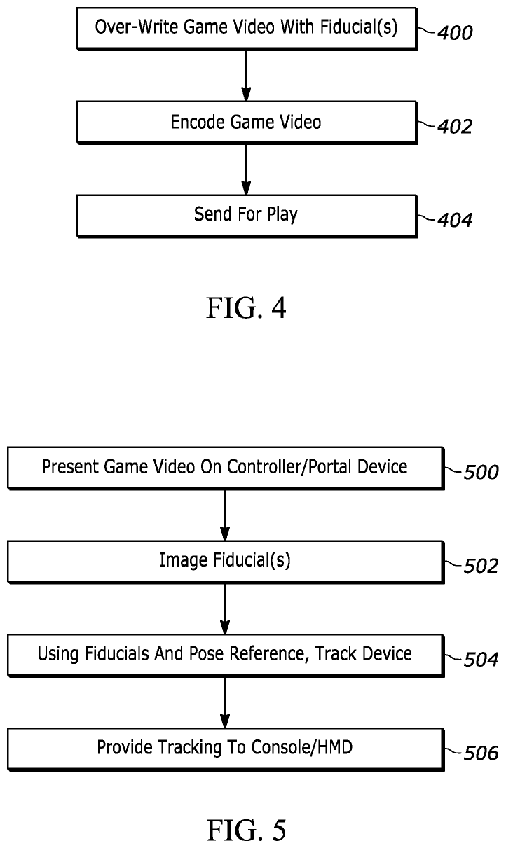

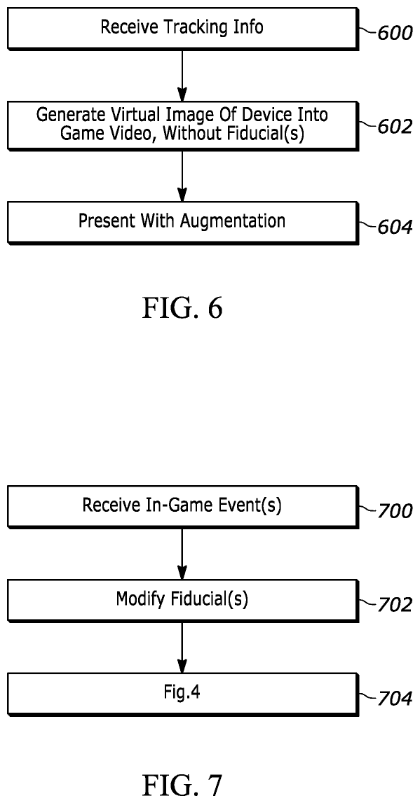

Now refer to FIG. 4. In one non-limiting implementation, tracking of LED-unsupported devices such as the device 300 may be afforded using PlayStation's Remote Play feature, which allows users stream gameplay from PlayStation consoles on any compatible device. Besides the gameplay, Remote Play supports the overlaying of images on the gameplay video. Commencing at state 400 in FIG. 4, original gameplay video data is overwritten with one or more fiducial markers (FM) prior to encoding at state 402. The encoded game video is then sent at state 404 to the device 300 for presenting the game video thereon along with the visible FM to enable the tracking of the device 300 as illustrated further in FIG. 5.

It should be noted that the logic of FIG. 4 is particularly useful for cloud streaming, in which a single bitstream is used to convey the game video and the fiducial markers to both the device 300 and the VR headset. In cases in which a game is streamed from a local console, multiple bitstreams may be used, and the bitstream sent to the device 300 need only contain the fiducial markers and no game video, with the bitstream sent to the VR headset including only the game video.

Commencing at state 500 in FIG. 5, a video game may be presented on the device 300, particularly in cloud applications. The FM onscreen with the video is/are imaged at state 502 by, e.g., one or more cameras on the HMD 200 shown in FIG. 2, or on a nearby game console.

Proceeding to state 504, using information encoded in and/or derived from the FM (such as relative size of a known FM in an image), the device 300 is tracked, i.e., the real world (RW) location/position/pose of the device in the RW is determined. This determination may entail determining a relative pose of the device 300 with respect to a coordinate system defined by the imaging device, the RW location/pose of which is known from, e.g., location sensors/IMU/motion sensors, etc., examples of which are depicted in FIG. 1 and described above. In this way, the RW location/pose of the device 300 is known and may be passed at state 506 to a source of the video being streamed to the device 300 and/or to a HMD 202 that is worn by a player holding the device 300, so that a virtualization of the device 300 may be presented at the correct location in VR space being presented on the HMD.

FIG. 6 illustrates further. At state 600 the FM-derived tracking information for the device 300 is received as described above. Proceeding to state 602 a virtual image of the device 300 is generated for display on the HMD 202. Particularly but not exclusively for cloud applications, the virtual image may show the identical game video being shown on the RW device 300 (i.e., virtual video frame shown on the HMD at time t=1 is the same as the video frame shown on the RW device 300 at time t=1) except that the FM are cropped from the virtual image for presentation at state 604 on the HMD, with or without augmentation. After the FM are cropped, the remaining virtual image of the video may be upscaled to fill the entire virtual screen of the virtual device 300 being shown on the HMD.

Augmentation at state 604 in FIG. 6 may include features from FIG. 7. In-game events such as boss kills, weapons deployment, and the like may be identified at state 700. In response, the one or more FM may be dynamically modified at state 702 for unlocking a trophy, with the modified FM subsequently being used in the logic of FIG. 4 at state 704. The virtual PlayStation Portal may be rendered with a special skin to increase immersion. Additional details of this facet of use of the FMs are described further below.

By enabling accurate tracking of the RW device 300, the virtual image of the device on the HMD may show in advance the next button to be pressed for difficult levels as an enhancement of the Game Help feature. Quick Time Events can be indicated by lighting up the corresponding buttons on the virtual image of the device 300.

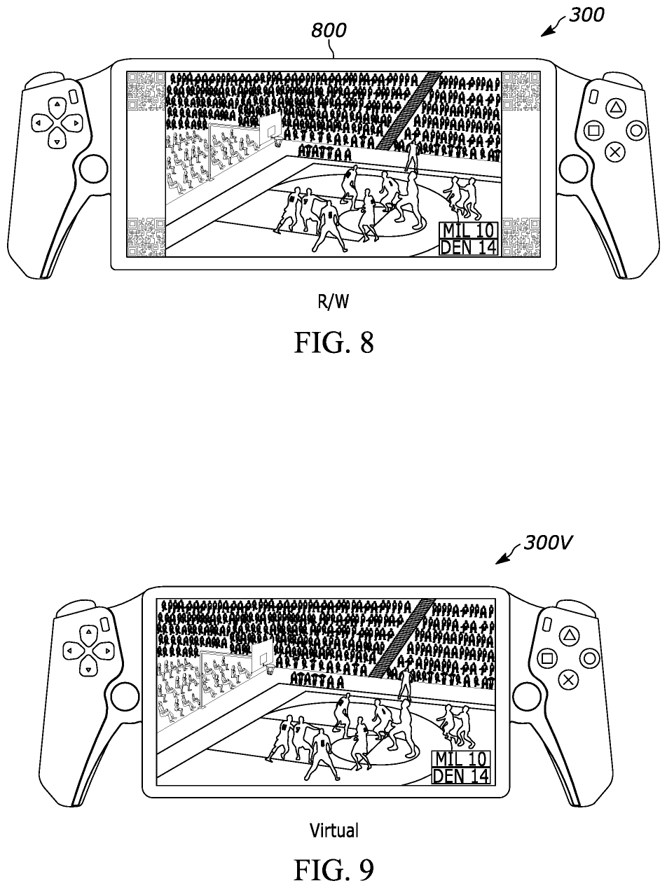

FIG. 8 illustrates that the display of the device 300 may present a computer simulation such as a video game along with one or more FM 800, in the example shown, QR codes located at respective corners of the display and each indicating, among other data, which corner it is in. As alluded to above, however, particularly for games sent from local consoles, the bitstream sent from a local console to the device 300 may include only the FMs and no video.

FIG. 9, on the other hand, illustrates the virtual image 300V of the device 300 as presented on the HMD 202. Note that the virtual image 300V shows an image of the device 300 including the identical computer simulation being shown on the device 300, except that the FM 800 have been cropped and the display portion in the virtual image 300V upscaled to fill the entire screen of the virtual image 300V.

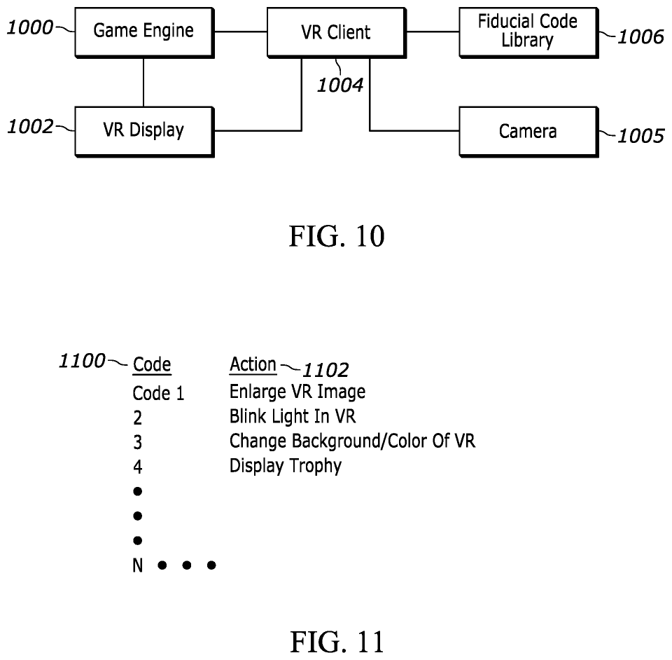

Turn now to FIGS. 10 and 11. A video game engine 1000 (more generally, a program to generate a computer simulation for presentation on one or more displays) may send video information to one or more displays 1002. The video game engine may be a legacy game engine that generates 2D (cinematic) video for flat displays. To add an immersion aspect for VR applications, a VR client application 1004 may communicate with the game engine 1000 to obtain game event data from the game engine 1000 and to obtain images, e.g., of FMs from a camera 1005 on, e.g., the VR headset. The game event data can be used to generate new FMs to present on the device 300 that act, in addition to locators, as action triggers. For example, the player side can signal game events to the transmitter (source) side to cause the source to overlay FMs onto the video or otherwise add FMs to a bitstream indicating not only device 300 tracking information but also the particular game event. The FMs once received by the receiver side are imaged by the camera 1005 and provided to the VR client 1004, which can correlate the FMs to actions using a data structure 1006 such as a lookup table correlating the FMs to respective VR-specific actions not otherwise provided for by the game engine 1000.

In addition to the actions described above, the FMs can be used as follows. As shown in FIG. 11, FM codes in a left column 1100 can be correlated to VR actions in a right column 1102.

For example, if the game engine indicates that a trophy has been won by a player accomplishing a task, a FM indicating a won trophy may be presented on the device 200 and imaged. The image can be correlated by the VR client 1004 accessing the data structure 1006 in FIG. 10 to particular VR action, i.e., to video enhancements to be presented on the HMD 202 in FIG. 2, such as presenting neon lights or enlarging the VR image or screen of the device 300 presented on the HMD. Or, depending on the in-game event, a QR code may be generated, imaged, and correlated to other VR enhancements such as blinking lights in VR on the HMD, changing a background illumination or color on the VR HMD, and displaying an image of a trophy on the HMD. A wide variety of video enhancements not otherwise provided for by the game engine 1000 may in this manner be implemented based on a variety of in-game events. Other enhancements include illuminating control elements on the image of the device 300 presented on the HMD as appropriate for preferred next steps following an in-game event, showing a bent or deformed device 300 on the HMD, scaling the image of the device 300 on the HMD up or down, and add animations into the game video presented on the HMD.

While the particular embodiments are herein shown and described in detail, it is to be understood that the subject matter which is encompassed by the present invention is limited only by the claims.

What is claimed is:

1. An apparatus comprising:
at least one virtual reality (VR) headset;
at least one component separate from the VR headset and comprising at least one display;
at least one source of at least one computer simulation presentable on the VR headset, at least one visible fiducial marker being presented on the component, an image of the component playing the computer simulation being displayed on the VR headset without the at least one visible fiducial marker, the image of the component displayed on the VR headset being based at least in part on an image of the fiducial marker.

2. The apparatus of claim 1, wherein the at least one fiducial marker is useful for tracking the component for presenting the image of the component on the VR headset.

3. The apparatus of claim 1, wherein the component is configured to present the computer simulation with the visible fiducial marker superimposed on the computer simulation, the computer simulation presented on a display of the component being identical to the computer simulation when presented on the VR headset except that the computer simulation when presented on the display of the component is shown with the at least one visible fiducial marker and the computer simulation when presented on the VR headset is shown with no visible fiducial markers.

4. The apparatus of claim 3, wherein the computer simulation when presented on the VR headset is presented on a virtualization of the component separate from the VR headset.

5. The apparatus of claim 3, wherein the at least one fiducial marker in the computer simulation when presented on the VR headset is cropped out and the computer simulation up-scaled when presented on the VR headset.

6. The apparatus of claim 1, comprising plural fiducial markers in respective corners of the computer simulation.

7. The apparatus of claim 1, wherein the at least one fiducial marker comprises a quick response (QR) code representing tracking information.

8. The apparatus of claim 1, wherein the fiducial marker is in response to an in-game action and is correlatable to a video enhancement on the VR headset not sourced from the source of the computer simulation.

9. A device comprising:
at least one computer storage that is not a transitory signal and that comprises instructions executable by at least one processor assembly to:
receive from at least one camera at least one image of at least one component of a computer simulation system;
based at least in part on at least one fiducial marker in the at least one image, generate a virtual representation of the component;
based at least in part on the at least one fiducial marker in the at least one image, generate a video enhancement; and
present the virtual representation of the component and the video enhancement in at least one computer simulation on a virtual reality (VR) display without the fiducial marker.

10. The device of claim 9, wherein the at least one fiducial marker in the at least one image is part of a presentation of the computer simulation being presented on the component.

11. The device of claim 9, wherein the component has no tracking lamps.

12. The device of claim 10, wherein the instructions are executable to:
based at least in part on at least one fiducial marker in the at least one image, generate tracking information for placing the virtual representation of the component in the at least one computer simulation on the VR display.

13. The device of claim 12, wherein the instructions are executable to:
generate the tracking information at least in part by correlating locations of the fiducial markers in the at least one image to respective locations on the component, and using the locations on the component to generate the virtual representation of the component.

14. The device of claim 10, wherein the computer simulation when presented on the component is identical to the computer simulation when presented on the VR display except that the computer simulation when presented on the component is shown with the at least one visible fiducial marker and the computer simulation when presented on the VR display is shown with no visible fiducial markers.

15. The device of claim 14, wherein the at least one fiducial marker in the computer simulation when presented on the VR display is cropped out and the computer simulation up-scaled when presented on the VR display.

16. The device of claim 10, comprising plural fiducial markers in respective corners of the computer simulation.

17. A method comprising:
presenting at least one computer simulation on at least one display of at least one component;
presenting, in the computer simulation on the display of the component, at least one fiducial marker;
imaging the fiducial marker;
generating information using the imaging useful for generating an image of the component; and
presenting the image of the component on at least one display other than the component.

18. The method of claim 17, wherein presenting the image of the component on the at least one display comprises presenting an image of the computer simulation as shown on the component except that the fiducial marker is not shown in the image of the component on the at least one display.

19. The method of claim 18, comprising cropping out the fiducial marker in the image of the component on the at least one display.

20. The method of claim 18, comprising generating information using the imaging useful for presenting a video enhancement of the computer simulation on the display.
